(19) United States
(12) Patent Application Publication
(10) Pub. No.: US 2016/0273734 A1
(43) Pub. Date: Sep. 22, 2016

(54) OPTICAL SYSTEM FOR AN LED LIGHT SOURCE AND LUMINAIRE COMPRISING SUCH AN OPTICAL SYSTEM

(71) Applicant: ZUMTOBEL LIGHTING GMBH, Dornbirn (AT)

(72) Inventors: Patrik GASSNER, St. Gerold (AT); Melanie HAGENBRING, Amsterdam (NL)

(21) Appl. No.: 15/029,495

(22) PCT Filed: Oct. 15, 2014
(86) PCT No.: PCT/EP2014/072077

§ 371 Date: Apr. 14, 2016

(30) Foreign Application Priority Data
Oct. 18, 2013 (DE) 10 2013 221 163.5

(51) Int. Cl. F21V 7/06; F21S 8/04; F21V 7/22; F21V 7/09; F21V 13/04; F21V 5/04

(52) U.S. Cl. CPC F21V 7/06; F21V 13/04; F21V 5/04; F21V 7/22; F21V 7/09; F21S 8/04; F21Y 2101/02

(57) ABSTRACT

An optical system for influencing light emitted by a LED light source. The system includes a lens for influencing the light, and a pot-like reflector, the shape of which defines a principal axis. The reflector has inwardly facing, reflective surface regions and forms a light exit opening with respect to the principal axis on a first side. The lens is arranged on a second side opposite the first side of the reflector, so that the light after emerging from the lens covers a path to the light exit opening and subsequently leaves the reflector through the light exit opening. The system is designed so a predominant portion of the light on the path between the lens and the light exit opening is not reflected at the reflective surface regions of the reflector and a further, smaller portion of the light is reflected at the reflective surface regions of the reflector.

The invention relates to an optical system for influencing light emitted by an LED light source (LED: light emitting diode), said optical system comprising a lens and a pot-like reflector. Furthermore, the invention relates to a luminaire comprising such an optical system.

The prior art discloses a louver luminaire, wherein the light generated by one light source or a plurality of light sources of the luminaire is emitted via the louver into an external space of the luminaire; in that case, the louver is formed by a plurality of pot-like reflectors arranged in one plane. For a user of such a luminaire, in practice it is regularly of significance what light appearance can be generated by the luminaire on a surface, for example a work surface. Such a light appearance is generally perceived as more or less pleasant.

The invention is based on the object of specifying an improved optical system for influencing light emitted by an LED light source, and a corresponding luminaire. In particular, the system and the luminaire are intended to be suitable for generating a particularly appealing light appearance.

This object is achieved according to the invention by means of the subjects mentioned in the independent claims. Particular types of embodiment of the invention are specified in the dependent claims.

The invention provides an optical system for influencing light emitted by an LED light source. The optical system comprises a lens for influencing the light, and a pot-like reflector, the shape of which defines a principal axis. The reflector has inwardly facing, reflective surface regions and forms a light exit opening with respect to the principal axis on a first side. In this case, the lens is arranged on a second side—opposite the first side—of the reflector, specifically in such a way that the light after emerging from the lens covers a path to the light exit opening and subsequently leaves the reflector through said light exit opening. The optical system is designed in this case in such a way that a predominant portion of the light on the path between the lens and the light exit opening is not reflected at the reflective surface regions of the reflector and only a further, smaller portion of said light is reflected at the reflective surface regions of the reflector.

What can be achieved in this way is that the light emission of the optical system is primarily or principally determined by the lens. The influence of the reflector is thus correspondingly reduced; in association with the generation of the light appearance, this design makes it possible to avoid or indeed at least significantly reduce any formation of undesirable hard shadow edges. In this case, a minimum shielding angle for the light emission can nevertheless be ensured. Moreover, the light distribution can be influenced by the reflector in the form of a “fine tuning”.

Preferably, in this case, the predominant portion is at least 80%, in particular at least 90%. The further, smaller portion is preferably between 1% and 9%, in particular between 3% and 7%. Particularly good results can be achieved in this way.

The reflector is preferably arranged in such a way that the reflective surface regions partly surround the lens in a ring-like fashion. What can be achieved in this way is that light portions emerging laterally from the lens can be purposefully influenced particularly suitably with the corresponding surface regions of the reflector.

Preferably, the reflective surface regions of the reflector are diffusely reflective or scattering. In this way, any formation of hard shadow edges can be particularly effectively reduced or avoided. Advantageously, the reflective surface regions of the reflector can be white for this purpose.

Alternatively, however, the reflective surface regions of the reflector can also be designed as specularly reflective. A more extensively improved suppression of glare can be achieved as a result.

Depending on the way in which the reflector is intended to influence the light emission, it is thus possible to use different materials for the reflector or to realize the reflective properties in different ways. Advantageously in terms of production engineering, the reflective surface regions of the reflector are formed by a coating; by way of example, they can be formed by a—generally highly lustrous—lacquering or a powder coating—usually having a more matt finish.

Preferably, the reflector is designed such that in a section through the principal axis the reflective surface regions describe a bell shape or a trapezoid shape. This makes it possible to bring about a particularly suitable influencing of the light distribution by the reflector.

Preferably, the reflector is shaped rotationally symmetrically with respect to the principal axis; alternatively, it can have a square or generally a rectangular or elliptical shape in a cross section normal to the principal axis.

The lens preferably consists of a clear material, for example of plastic or glass. That is advantageous particularly with regard to the photometric efficiency of the luminaire.

Preferably, the optical system is designed in such a way that—as viewed in a section through the principal axis—a tangent which touches the lens and is placed on the opposite side of the principal axis through the marginal point of the light exit opening forms with the principal axis an angle that is at most 60°. By means of this design, a minimum shielding angle can be realized in a particularly suitable way.

Preferably, the optical system is designed in such a way that—as viewed in a section through the principal axis—the extent of the lens normal to the principal axis is at least 35% of the extent of the light exit opening, in particular at least 40%. What can be brought about particularly suitably in this way is that the light influencing by the lens is accorded a correspondingly high proportion of the influencing of the light by the entire system.

A further aspect of the invention provides a luminaire, comprising an LED light source and an optical system according to the invention. In this case, the luminaire is particularly suitably designed as a ceiling luminaire, in particular as a workspace luminaire. Preferably, in this case, a light exit opening of the luminaire is described by the light exit opening of the reflector. That is advantageous with regard to the photometric efficiency of the luminaire.

The invention is explained in greater detail below on the basis of an exemplary embodiment and with reference to the drawings, in which:

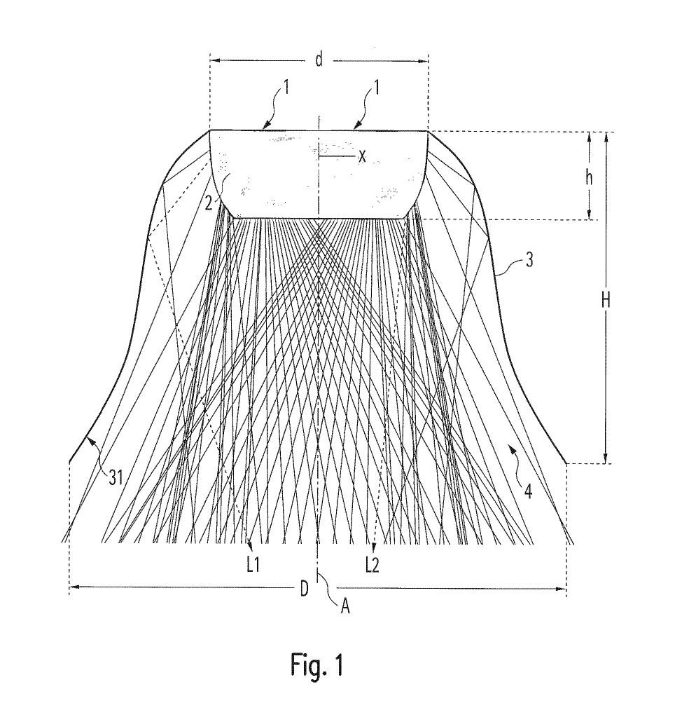

FIG. 1 shows a schematic cross-sectional diagram concerning an optical system according to the invention,

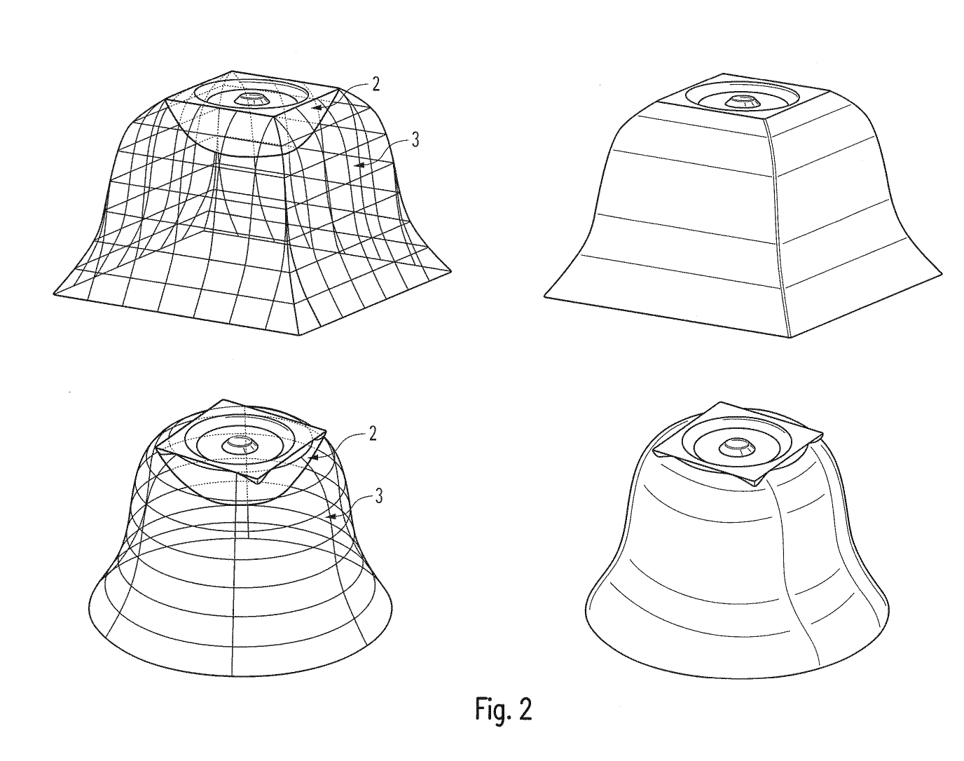

FIG. 2 shows schematic diagrams concerning two different configurational design possibilities for the optical system,

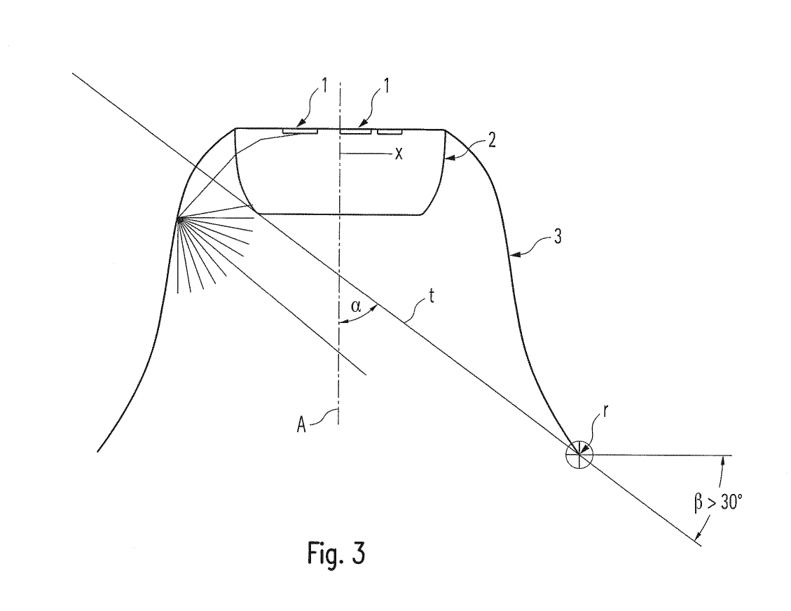

FIG. 3 shows a schematic diagram, corresponding to FIG. 1, for elucidating the achieving of a minimum shielding angle,

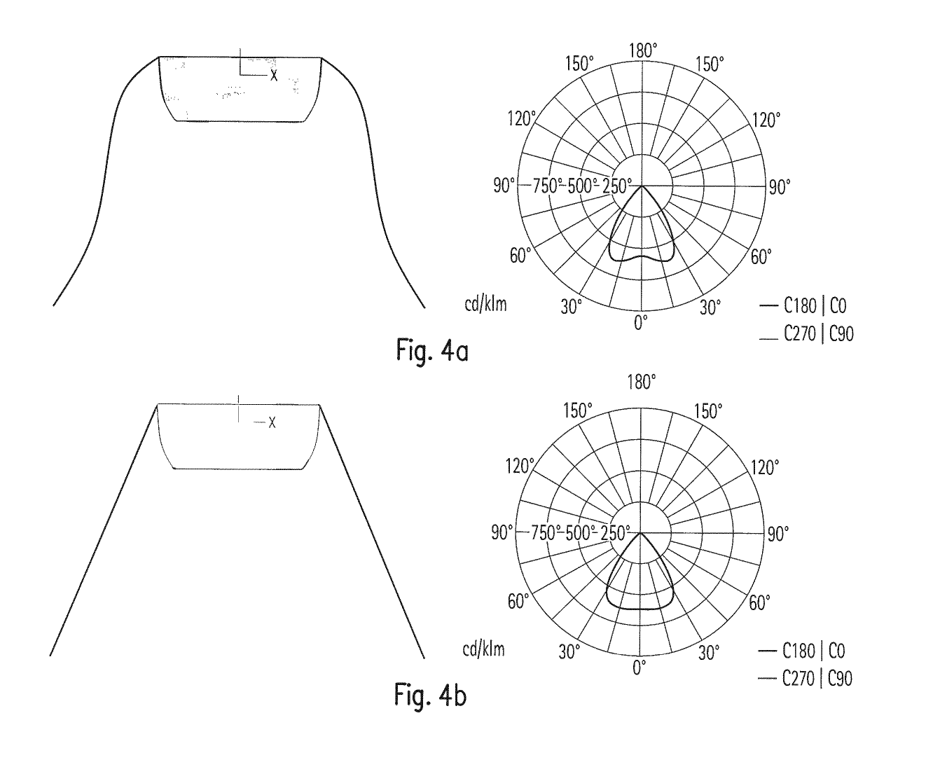

FIG. 4a shows a schematic diagram concerning a possible achievable luminance distribution in the case of a bell-shaped reflector, and

FIG. 4b shows a corresponding schematic diagram in the case of a reflector in the shape of a cone section.

FIG. 1 shows a schematic cross-sectional diagram concerning an optical system according to the invention. The optical system is configured for influencing light generated by an LED light source 1. The system comprises a lens 2 for influencing the light, and a pot-like reflector 3.

The reflector 3 is designed such that its shape defines a principal axis A. The reflector 3 extends around said principal axis A and has inwardly facing, reflective surface regions 31. Preferably, the entire surface region of the reflector 3 facing inward with respect to the principal axis A is formed exclusively by the reflective surface regions 31.

The extent of the reflector 3 along the principal axis A is designated here as the height H of the reflector 3.

A light exit opening 4 is formed by the reflector 3 with respect to the principal axis A on a first side. It is assumed in this description that the reflector 3 is oriented such that the principal axis A runs vertically and the first side faces downward, that is to say that the light exit opening 4 faces downward. However, in principle the optical system can also be provided or designed for being oriented in some other way relative to the vertical for operation. The direction indications, etc. in the present description should be correspondingly reinterpreted in such a case.

As indicated in FIG. 2, at the bottom, the reflector 3 can be shaped rotationally symmetrically for example with respect to the principal axis A or—as indicated in FIG. 2 at the top—the reflector can have a polygonal, for example square, shape in a cross section normal to the principal axis A.

In this case, the lens 2 is arranged on a second side—opposite the first side—of the reflector 3 or at the top of the reflector 3. In this case, the design is such that the light after emerging from the lens 2 covers a path to the light exit opening 4 and subsequently leaves the reflector 3 through said light exit opening. In particular, the lens 2 can be arranged in a manner passing through the principal axis A.

In the example shown, the reflector 3 is arranged in such a way that the reflective surface regions 31 partly surround the lens 2 in a ring-like fashion, specifically along a section h of the principal axis A. Said section h can correspond in particular to the extent of the lens 2 parallel to the principal axis A. With regard to the dimensioning, provision can be made, for example, for the following relation to hold true: 0.1 H<h<0.5 H, preferably 0.2 H<h<0.3 H.

At its end region facing the second side, or that is to say at its upper end region, the reflector 3 can have an opening into which the lens 2 is inserted. Preferably, the design is such that the lens 2 is arranged in a manner directly adjacent to the reflective surface regions 31 of the reflector 3.

Furthermore, the reflector 3 can be designed in such a way that—as viewed in a section through the principal axis A—the extent d of the lens 2 normal to the principal axis A is at least 35% of the extent D of the light exit opening 4, preferably at least 40%. What can be achieved particularly suitably in this way is that that surface region of the lens 2 via which the light leaves the lens is comparatively large. As a result, particularly suitable light influencing is made possible; moreover, the risk of an observer being potentially dazzled by a very high local luminance can be reduced in this way.

A luminaire according to the invention comprises the LED light source 1 in addition to the optical system. The LED light source 1 can comprise one LED or a plurality of LEDs, in particular arranged in a cluster. The LEDs can be arranged in this case—for example on a circuit board—in such a way that they passed through a plane oriented normally to the principal axis A. The luminaire can be designed as an interior luminaire. The luminaire can be embodied for example as a ceiling luminaire or as a standard lamp and can serve in particular for illuminating a substantially horizontally work surface, that is to say can be designed as a workspace luminaire. A particularly suitable light appearance giving a pleasant impression can be generated on said work surface by the light emitted by the luminaire.

The luminaire can also comprise a plurality of corresponding optical systems and a plurality of corresponding LED light sources, wherein each of the LED light sources is assigned one of the optical systems. In particular, the luminaire can be designed such that the reflectors of the optical systems are arranged in one plane and form a louver arrangement. In this case, the optical systems are preferably of structurally identical design. The LED light sources, too, can be of structurally identical design. In this case, provision can furthermore be made for the luminaire to be oriented for operation in such a way that the reflectors are arranged in a manner passing through a horizontal plane and light is emitted by the luminaire downward through the louver arrangement.

Preferably, the design of the luminaire is such that a light exit opening of the luminaire is described by the light exit opening 4 or if appropriate, by the light exit openings. This makes it possible to prevent the light from being influenced by further luminaire components after passing through the light exit opening 4.

The optical system is preferably arranged relative to the LED light source 1 such that the light generated and emitted by the LED light source 1 is radiated into the lens 2 from above, passes through the lens 2 and leaves the latter again through surface regions of the lens 2 that face downward and toward the sides. As already mentioned, the light after emerging from the lens 2 then covers a path to the light exit opening 4 of the reflector 3. In this case, the light comprises—as indicated by way of example by a first light ray L1 in FIG. 1—first light rays, which are reflected or scattered on said path at the reflective surface regions 31 of the reflector 3, and—as indicated by way of example by a second light ray L2 in FIG. 1—second light rays, which are not reflected at the reflective surface regions 31 of the reflector 3 on said path.

The optical system is designed in such a way that a predominant portion of the light on the path between the lens 2 and the light exit opening 4 is not reflected at the reflective surface regions 31 of the reflector 3 and only a further, smaller portion of said light is reflected or scattered at the reflective surface regions 31 of the reflector 3. If, as shown by way of example in FIG. 1, the light on its path between the lens 2 and the light exit opening 4 is represented by light rays, specifically such that the density of the light rays represents a measure of the intensity of the light, then there are correspondingly more second light rays L2 and fewer first light rays L1. In other words, in particular, the expressions “predominant portion” and “further, smaller portion” can relate to the intensity the light.

By way of example, provision can be made for the predominant portion to be at least 80%, preferably at least 90%. The further, smaller portion can be for example between 1% and 9%, preferably between 3% and 7%.

What can be achieved by this design is that the light distribution brought about by the optical system is primarily determined by the lens 2. By contrast, the reflector 3 has a small influence thereon.

In order to suitably realize a correspondingly large influence by the lens 2, provision is preferably made for the lens 2 to consist of a clear material. By way of example, the lens 2 can consist of plastic or glass. The use of a clear material also makes it possible to prevent appreciable scattering of the light from occurring in the lens 2.

Nevertheless, the following three effects with regard to the light distribution can be achieved particularly advantageously with the reflector 3:

By means of corresponding shaping of the reflector 3 and of the lens 2 it is possible—as indicated schematically in FIG. 3—suitably to achieve a minimum shielding angle β of the optical system, which minimum shielding angle makes it possible to prevent an observer from being potentially dazzled in an undesirable way. For this purpose, the design is preferably such that—as viewed in a section through the principal axis A—a tangent t which touches the lens 2 and is placed on the opposite side of the principal axis A through the marginal point r of the light exit opening 4 forms with the principal axis A an angle α that is at most 90°—β. If the minimum shielding angle β is thus at least 30°, for example, in accordance with the customary standard, then the optical system is preferably designed geometrically such that the angle α is a maximum of 60°.

What can furthermore be brought about by the reflector 3 is that in the light appearance that can be generated by the light emitted by a corresponding luminaire—for example on a correspondingly illuminated work surface—hard shadows are avoided or indeed at least significantly reduced. This can be achieved in particular by virtue of the fact that that portion of the light which impinges on the reflective surface regions 31 of the reflector 3, that is to say the further, smaller portion of the light, is slightly scattered, that is to say reflected diffusely, at the surface regions 31. For this purpose, preferably, the surface regions 31 are accordingly designed to be diffusely reflective or scattering; in particular, the surface regions 31 can be designed to be white. Advantageously in terms of production engineering, the reflector 3 can be produced from a white material.

The effect mentioned can in particular also be achieved in the case of a luminaire according to the invention which has the louver arrangement mentioned above. In this case there is in principle the probability of edges being formed by multiple shadows; said edges can be correspondingly avoided or at least reduced by the design according to the invention.

The reflector 3 can consist of or be produced from plastic or a lacquered or differently coated material, for example. In particular, the reflective surfaces 31 can be formed by a coating, for instance by a lacquering or a powder coating.

The light distribution is thus primarily brought about by the lens 2; however, in this case a “fine tuning” of the light distribution can be brought about by the reflector 3, in particular by corresponding shaping of the reflector 3. As depicted schematically by way of example in FIG. 1 and also in FIG. 4a, on the left, the reflector 3 can be designed for example such that, in a section through the principal axis A, the reflective surface regions 31 describe a bell shape. As depicted schematically in FIG. 4b, on the left, the shaping can alternatively be such, for example, that the reflective surface regions 31 in this case describe a trapezoid shape; overall, in this case, the surface regions 31 can thus describe a shape of a cone section. In a cross section normal to the principal axis A, the reflector can have for example a square, rectangular or elliptical shape, in particular also a circular shape. The corresponding influences on the light distribution curve are correspondingly shown in FIG. 4a, on the right, and FIG. 4b, on the right. While a bell shape leads to formation of a slightly manifested two-wing “batwing distribution”, the two-wing manifestation is weaker in comparison therewith in the case of the trapezoidal design or design in the shape of a cone section. More light is then directed into the region between the two “wings”.

Moreover, for example by means of corresponding shaping of the reflector 3, the scattered light above 65° can be easily reduced in order to reduce luminances.

As indicated above, the reflector 3 can be designed such that the light is diffusely reflected or scattered at the reflective surface regions 31. However, alternatively, it is also possible for the surface regions 31 to be designed as specularly reflective. In this way it is possible to achieve further improved suppression of glare, if appropriate, or it is possible to have even more influence on the emission characteristic.

With regard to a common effect of the lens 2 and of the reflector 3 it should be noted, finally, that in principle the lens 2 should be all the clearer, the more highly diffuse the effect of the reflector 3. However, if the lens 2 itself has certain scattering properties, for example as a result of incorporated scattering particles, the reflector 3 should be correspondingly designed to have a less diffuse effect.

1. An optical system for influencing light emitted by an LED light source, comprising:
a lens for influencing the light, and
a pot-like reflector, the shape of which defines a principal axis, wherein the reflector has inwardly facing, reflective surface regions and forms a light exit opening with respect to the principal axis on a first side, wherein the lens is arranged on a second side opposite the first side of the reflector, in such a way that the light after emerging from the lens covers a path to the light exit opening and subsequently leaves the reflector through said light exit opening,
wherein the optical system is designed in such a way that a predominant portion of the light on the path between the lens and the light exit opening is not reflected at the reflective surface regions of the reflector and only a further, smaller portion of said light is reflected at the reflective surface regions of the reflector.

2. The optical system as claimed in claim 1, wherein the predominant portion is at least 80%.

3. The optical system as claimed in claim 1, wherein the further, smaller portion is between 1% and 9%.

4. The optical system as claimed in claim 1, wherein the reflector is arranged in such a way that the reflective surface regions partly surround the lens in a ring-like fashion.

5. The optical system as claimed in claim 1, wherein the reflective surface regions of the reflector are diffusely reflective or are specularly reflective.

6. The optical system as claimed in claim 1, wherein the reflective surface regions of the reflector are white.

7. The optical system as claimed in claim 1, wherein the reflective surface regions of the reflector are formed by a coating, in particular by a lacquering or a powder coating.

8. The optical system as claimed in claim 1, wherein the reflector is designed such that in a section through the principal axis the reflective surface regions describe a bell shape or a trapezoid shape.

9. The optical system as claimed in claim 1, wherein the reflector is shaped rotationally symmetrically with respect to the principal axis or has a square, rectangular or elliptical shape in a cross section normal to the principal axis.

10. The optical system as claimed in claim 1, wherein the lens consists of a clear material, in particular of plastic or glass.

11. The optical system as claimed in claim 1, which is designed in such a way that—as viewed in a section through the principal axis—a tangent which touches the lens and is placed on the opposite side of the principal axis through the marginal point of the light exit opening forms with the principal axis an angle that is at most 60°.

12. The optical system as claimed in claim 1, which is designed in such a way that, as viewed in a section through the principal axis, the extent of the lens normal to the principal axis is at least 35% of the extent of the light exit opening.

13. A luminaire, comprising:
an LED light source, and
an optical system as claimed in claim 1.

14. The luminaire as claimed in claim 13, in the form of a ceiling luminaire, in particular a workspace luminaire.

15. The luminaire as claimed in claim 13, wherein a light exit opening of the luminaire is described by the light exit opening of the reflector.

16. The optical system as claimed in claim 1, wherein the predominant portion is at least 90%.

17. The optical system as claimed in claim 1, wherein the further, smaller portion is between 3% and 7%.

18. The optical system as claimed in claim 1, which is designed in such a way that, as viewed in a section through the principal axis, the extent of the lens normal to the principal axis is at least 40% of the extent of the light exit opening.
